(19) United States
(12) Patent Application Publication
(10) Pub. No.: US 2007/0170007 A1
(43) Pub. Date: Jul. 26, 2007

(54) Ball screw drive mechanism for an elevator

(75) Inventor: Chang-Hsin Kuo, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/285,577

(22) Filed: Nov. 22, 2005

(51) Int. Cl. B66B 9/02

(52) U.S. Cl. 187/267

(57) ABSTRACT

A ball screw drive mechanism for an elevator comprises: a screw shaft, an elevator car-connecting member connected to an elevator car, a ball nut screwed on the screw shaft, in an inner surface of the ball nut being formed a helical female groove, a plurality of balls rotatably arranged between the helical male groove and the helical female groove, and a sliding nut formed with a helical thread for meshing with the helical male groove. Between the helical thread and the helical male groove is a gap, when a relative rotation occurs between the screw shaft and the sliding nut, the sliding nut will move along the screw shaft, and the helical thread of the sliding nut doesn't contact the helical male groove of the screw shaft, however, when the ball nut is worn off so severely that it is unable to support load of the elevator, the thread of the sliding nut will contact the helical male groove of the screw shaft to support the load of the elevator.

### BACKGROUND OF THE INVENTION

1. Field of the Invention

The present invention relates to a drive mechanism for an elevator, and more particularly to ball screw drive mechanism for an elevator.

2. Description of the Prior Art

The elevator drive system generally includes screw drive system, oil pressure drive system, steel cable type drive system and linear motor drive system. The screw drive system has been used on elevator for almost one hundred years. However, the conventional screw elevator drive systems use sliding friction to achieve rotary transmission, the consequent friction drag is very great and the mechanical efficiency is as low as 30%, therefore, it is uneconomic in terms of power consumption. In addition, the high friction drag will result in a high temperature of the drive system.

To overcome the abovementioned shortcomings, in recent years, ball screw was used on the elevator as a new drive system to replace the conventional screw drive system. One of the advantages of the ball screw is that it has very low friction drag and high mechanical efficiency. Since the ball screw shaft utilizes the rolling motion of the steel balls to replace the sliding friction force of the conventional sliding friction type screw drive system. The friction coefficient of the ball screw is as low as 0.002, and the mechanical efficiency of the ball screw is improved from 30% to 95% as compared to the conventional sliding friction type screw drive system. However, the disadvantage is that the safety of the ball screw is relatively low as compared to the conventional sliding friction type screw drive system. The structure of the sliding nut of the conventional sliding friction type screw drive system is simple, it only needs to define some inner threads having a trapezoid cross section in the inner surface thereof, and such a simple structure will have a very low failure rate. Furthermore, the sliding nut will be worn off severely before it is broken, in other words, the degree of wear off of the sliding nut can be detected easily so as to prevent failure caused by the sliding nut. However, the ball screw drive system is complicated in structure since the ball nut includes at least steel balls, element for circulating the steel balls and a base whose inner diameter being formed with a helical female groove. The ball nut may be broken even before its helical female groove is severely worn off, for example, the steel balls may disengage from the ball nut. That is, the potential failure of the ball screw is difficult to be detected during the regular maintenance operation.

The present invention has arisen to mitigate and/or obviate the afore-described disadvantages.

### SUMMARY OF THE INVENTION

The primary objective of the present invention is to provide a low friction drag, high mechanical efficient and safe drive mechanism for an elevator, when the ball nut is severely worn off, the elevator car still can operate safely.

The secondary objective of the present invention is to provide a ball screw drive mechanism for an elevator, in case that the ball nut is broken, it can be detected and repaired in time, and thus potential accident can be prevented.

To achieve the abovementioned objects, the ball screw drive mechanism for an elevator in accordance with the present invention is in the form of a ball screw, which can improve the sliding friction drag caused problem of the conventional slide type screw shaft. The ball nut of the ball screw is a hollow structure whose inner surface being formed with a helical female groove, and a plurality of balls are received in the helical female groove. Through the rolling motion of the balls, sliding friction force can be prevented from being produced between the helical female groove and the screw shaft, thus reducing the frictional resistance of the ball nut with respect to the screw shaft, and improving the mechanical efficiency of the drive mechanism of the elevator.

In order to improve the safety of the ball screw drive mechanism for an elevator in accordance with the present invention, a sliding nut is disposed in the mechanism of the present invention. The sliding nut is a hollow structure being formed in inner surface with a helical thread, and the helical thread is semicircular shaped in cross section for meshing with the approximately semicircular-shaped male groove of the screw shaft. A gap is formed between the helical thread of the sliding nut and the helical male groove of the screw shaft. In normal condition, the helical thread doesn't contact the helical male groove, however, when the ball nut is unable to support load of the elevator, the helical thread of the sliding nut will contact the helical male groove of the screw shaft immediately to support the load of the elevator.

In addition, to make it easy to check the drive mechanism of the elevator, the gap between the helical thread and the helical male groove will change when the mechanism is worn off. Therefore, the degree of wear of the mechanism can be detected by measuring the width of the gap between the helical thread and the helical male groove. When the ball nut comes to failure and is unable to take the load of the elevator, the sliding nut will take the elevator's load. And when the load of the elevator is loaded on the sliding nut, the helical thread will have to contact the helical male groove, that is, the gap between the helical thread and the helical male groove will disappear. Thus, it is convenient to detect the failure of the ball nut. Meanwhile, due to the load of the elevator is transferred to the sliding nut, the drive mechanism still can take the load of the elevator car, thus preventing any potential unsafe condition.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a ball screw drive mechanism for an elevator in accordance with a first embodiment of the present invention;

FIG. 2 is an enlarged cross sectional view of showing a part of the ball screw elevator drive mechanism;

FIG. 3 shows a ball screw drive mechanism for an elevator in accordance with a second embodiment of the present invention;

FIG. 4 is an enlarged cross sectional view of showing a part of the ball screw elevator drive mechanism in accordance with the second embodiment of the present invention;

FIG. 5 is an enlarged cross sectional view of showing a part of the ball screw elevator drive mechanism in accordance with a third embodiment of the present invention;

FIG. 6 is an enlarged cross sectional view of showing a part of the ball screw elevator drive mechanism in accordance with a fourth embodiment of the present invention; and

FIG. 7 is an enlarged cross sectional view of showing a part of the ball screw elevator drive mechanism in accordance with a fifth embodiment of the present invention.

### DETAILED DESCRIPTION OF THE PREFERRED EMBODIMENTS

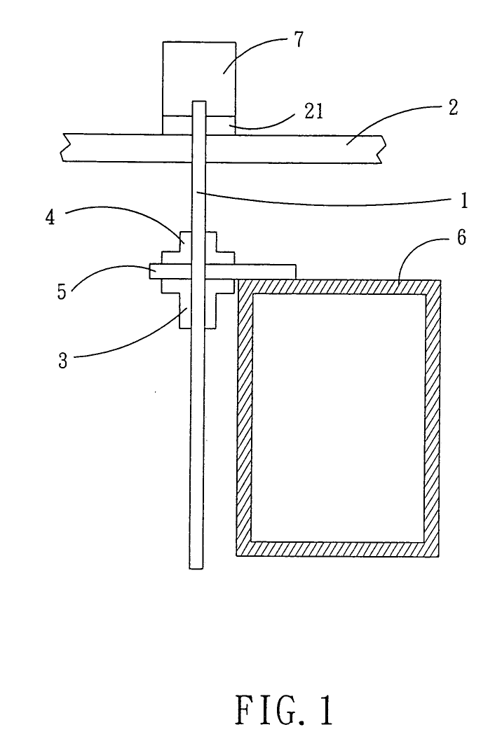

FIG. 1 shows a ball screw drive mechanism for an elevator in accordance with a first embodiment of the present invention, in which, the elevator comprises a screw shaft 1, a support beam 2, a ball nut 3, a sliding nut 4, an elevator car-connecting member 5, an elevator car 6 and a motor 7. An end of the screw shaft 1 is locked to the support beam 2 by a lock member 21, and the screw shaft 1 is fixed in the axial direction with respect to the support beam 2 but is rotatable relative to the support beam 2. The elevator car-connecting member 5 is connected to the elevator car 6 and moves along with the elevator car 6. The ball nut 3 is a hollow structure rotatably screwed on the screw shaft 1 and is fixed on the elevator car-connecting member 5, so as to drive the elevator car 6 to move along the screw shaft. The sliding nut 4 is also a hollow structure screwed on the screw shaft 1 and fixed on the elevator car-connecting member 5. The motor 7 is installed on the support beam 2 for rotating the screw shaft 1. When the motor 7 rotates the shaft 1, the ball nut 3, the sliding nut 4 and the elevator car-connecting member 5 will drive the elevator car 6 to move up and down along the screw shaft 1. The aforementioned support beam 2 refers to all types of support structures that don't move relative to a building, including the support structures fixed on the floor, the ceiling and the wall, and also including the building itself.

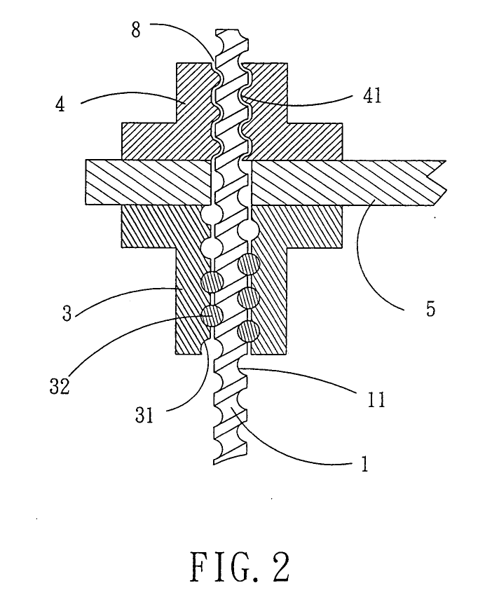

FIG. 2 is an enlarged cross sectional view of showing a part of the ball screw elevator drive mechanism, in the outer surface of the screw shaft 1 is formed a helical male groove 11 having an approximate semi-circular shape, and in the inner surface of the ball nut 3 is formed a helical female groove 31 for mating with the helical male groove 11. A plurality of balls 32 is rotatably arranged in the space between the helical male groove 11 and the helical female groove 31, and thus the ball nut 3 is also rotatable to the screw shaft 1, and during rotation, the ball nut 3 can move axially relative to the screw shaft 1. Due to the ball nut 3 is fixed to the elevator car-connecting member 5, the elevator car-connecting member 5 will move along with the ball nut 3. In the inner surface of the sliding nut 4 is formed a helical thread 41 for meshing with the helical male groove 11, the helical thread 41, the helical male groove 11 and the helical female groove 31 have the same lead. The helical thread 41 is semicircular in cross section for mating with the helical male groove 11. Between the helical thread 41 and the helical male groove 11 is a gap 8, when the screw shaft 1 rotates, the sliding nut 4 will move along the screw shaft 1 in such a manner the helical thread 41 doesn't contact the helical male groove 11. However, when the ball nut 3 is worn off so severely that it is unable to support the load, the sliding nut 4 will move downward relative to the helical male groove 11, so that the helical thread 41 will contact the helical male groove 11 to support the load, thus maintaining the movement of the elevator car 6 and the elevator car-connecting member 5 along the screw shaft 1.

Elevator is such equipment that needs to have a very high safety, and needs to be checked regularly during assembly and usage to ensure its safe operation. For easy check, the sliding nut 4 is deliberately designed to be exposed out of the ball screw drive mechanism, so that the width of the gap 8 can be measured from the outside directly by using thickness gauge. The gap 8 should be measured for each maintenance operation and the change of the width of the gap 8 can determine whether the ball nut needs to be repaired. When the ball nut 3 is broken, the helical thread 41 of the sliding nut 4 has to support the load of the elevator car 6, therefore, the sliding nut 4 is preferably made of high tensile material, such as the metal material or high tensile engineering plastic, the metal material includes steel. The steel is the best.

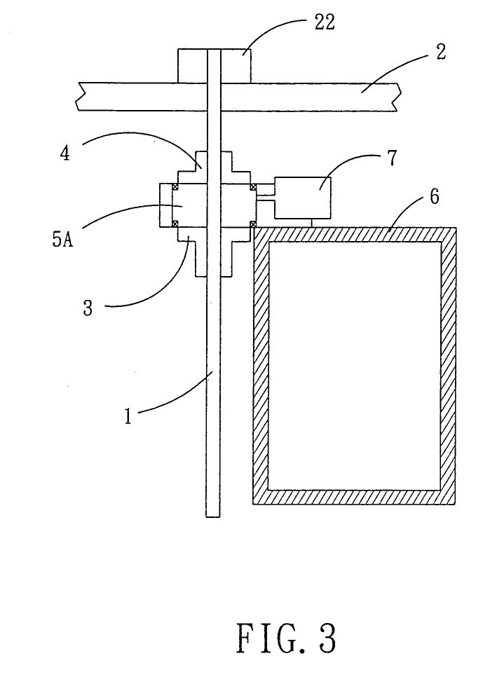

FIG. 3 shows a ball screw drive mechanism for an elevator in accordance with a second embodiment of the present invention, in which, the elevator comprises a screw shaft 1, a support beam 2, a ball nut 3, a sliding nut 4, an elevator car-connecting member 5A, an elevator car 6 and a motor 7. An end of the screw shaft 1 is locked to the support beam 2 by a lock member 22, and the screw shaft 1 is fixed in the axial direction with respect to and is also unmovable relative to the support beam 2. The elevator car-connecting member 5A is a hollow structure for insertion of the screw shaft 1, the elevator car-connecting member 5A is rotatable relative to the screw shaft 1, the elevator car-connecting member 5A is connected to the elevator car 6 and moves along with the elevator car 6. The ball nut 3 is a hollow structure rotatably screwed on the screw shaft 1 and is fixed on the elevator car-connecting member 5A, so as to drive the elevator car 6 to move along the screw shaft 1. The sliding nut 4 is also a hollow structure screwed on the screw shaft 1 and fixed on the elevator car-connecting member 5A. The motor 7 is installed on a structure that moves synchronously with the elevator car 6, for rotating the elevator car-connecting member 5A. When the motor 7 rotates, the screw shaft 1 will not rotate since it is fixed on the support beam 2, however, the ball nut 3 and the sliding nut 4 are fixed on the elevator car-connecting member 5A, so that the ball nut 3 and the sliding nut 4 will rotate to move along the screw shaft 1, thus causing upward and downward motion of the elevator car 6.

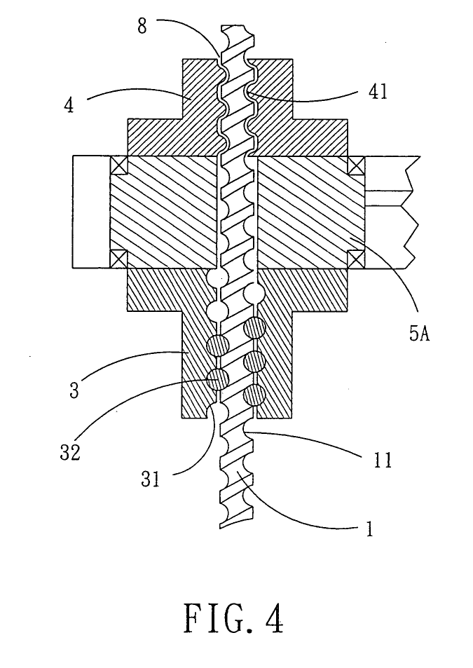

FIG. 4 is an enlarged cross sectional view of showing a part of the ball screw elevator drive mechanism in accordance with the second embodiment of the present invention, in the outer surface of the screw shaft 1 is formed a helical male groove 11 having an approximate semi-circular shape, and in the inner surface of the ball nut 3 is formed a helical female groove 31 for mating with the helical male groove 11. A plurality of balls 32 is rotatably arranged in the space between the male groove 11 and the helical female groove 31, and thus the ball nut 3 is also rotatable to the screw shaft 1, and during rotation, the ball nut 3 can move axially relative to the screw shaft 1. As mentioned above, the elevator car-connecting member 5A is also a hollow structure rotatably screwed on the screw shaft 1. For easy transmission of power from the motor to the elevator car-connecting member 5A, the elevator car-connecting member 5A can be a general gear, such as a spur or a worm gear. Due to the ball nut 3 is fixed to the elevator car-connecting member 5A, the elevator car-connecting member 5A will move along with the ball nut 3. In the inner surface of the sliding nut 4 is formed a helical thread 41 for meshing with the helical male groove 11, the helical thread 41, the helical male groove 11 and the helical female groove 31 have the same lead. The helical thread 41 is semicircular in cross section for mating with the helical male groove 11. Between the helical thread 41 and the helical male groove 11 is a gap 8, when the screw shaft 1 rotates, the sliding nut 4 will move along the screw shaft 1 in such a manner the helical thread 41 doesn't contact the helical male groove 11. However, when the ball nut 3 is worn off so severely that it is unable to support the load, the sliding nut 4 will move downward relative to the helical male groove 11, so that the helical thread 41 will contact the helical male groove 11 to support the load, so as to maintain the elevator car 6 and the elevator car-connecting member 5A moving along the screw shaft 1.

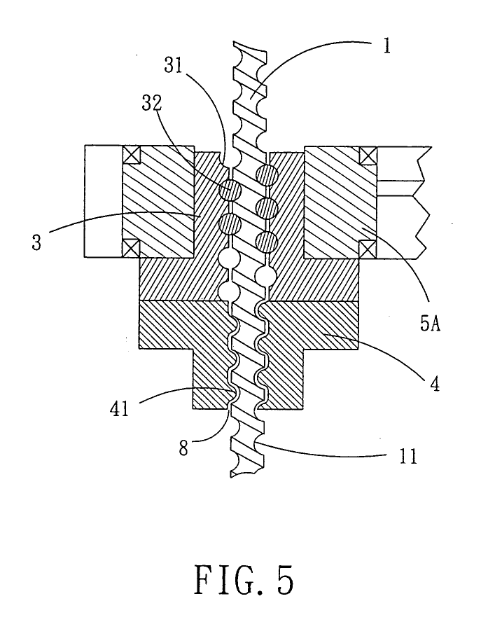

FIG. 5 is an enlarged cross sectional view of showing a part of the ball screw elevator drive mechanism in accordance with a third embodiment of the present invention, wherein the ball nut 3 is inserted in the elevator car-connecting member 5A, so that the length of the mechanism is relatively short. And, the length of the screw shaft 1 can be obviously shortened, too.

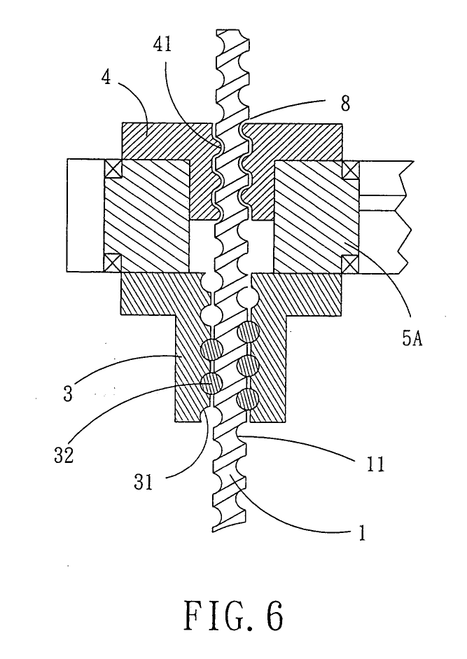

FIG. 6 is an enlarged cross sectional view of showing a part of the ball screw elevator drive mechanism in accordance with a fourth embodiment of the present invention, wherein the sliding nut 4 is inserted in the elevator car-connecting member 5A, so that the length of the mechanism is relatively short. And, the length of the screw shaft 1 can be obviously shortened, too. Due to the structure of the sliding nut 4 is very simple and its outer diameter is smaller than that of the ball nut 3, in this case, the size of the elevator car-connecting member 5A can be further reduced as compared to the third embodiment.

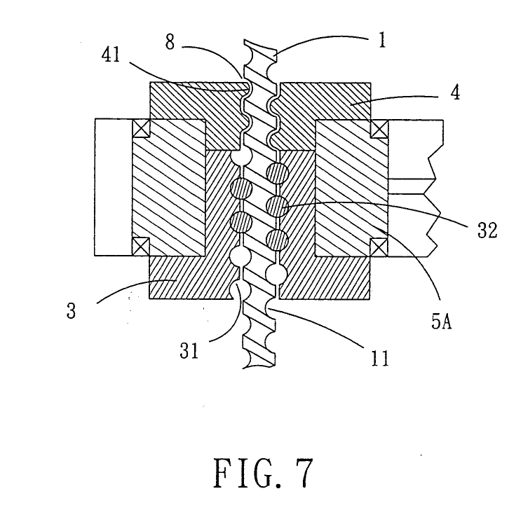

FIG. 7 is an enlarged cross sectional view of showing a part of the ball screw elevator drive mechanism in accordance with a fifth embodiment of the present invention, wherein both the ball nut 3 and the sliding nut 4 are inserted in the elevator car-connecting member 5A, so that the length of the mechanism can be much reduced.

While we have shown and described various embodiments in accordance with the present invention, it should be clear to those skilled in the art that further embodiments may be made without departing from the scope of the present invention.

1. A ball screw drive mechanism for an elevator comprising:
a screw shaft whose outer surface being formed with a helical male groove having an approximate semicircular cross section, an end of the screw shaft locked to a support beam of an elevator, and the screw shaft being fixed in an axial direction with respect to the support beam;
an elevator car-connecting member being connected to an elevator car and being moveable together with the elevator car;
a ball nut being a hollow structure rotatably screwed on the screw shaft and fixed to the elevator car-connecting member, in an inner surface of the ball nut being formed a helical female groove for mating with the helical male groove, a plurality of balls rotatably arranged in a space between the helical male groove and the helical female groove, and thus the ball nut is rotatable relative to the screw shaft, and during rotation, the ball nut will move axially relative to the screw shaft; and
a sliding nut being a hollow structure screwed on the screw shaft and fixed to the elevator car-connecting member, in an inner surface of the sliding nut being formed a helical thread for meshing with the helical male groove of the screw shaft, between the helical thread and the helical male groove is a gap, so that when a relative rotation occurs between the sliding nut and the screw shaft, the sliding nut will move along the screw shaft in such a manner the helical thread of the sliding nut doesn't contact the helical male groove of the screw shaft, however, when the ball nut is worn off so severely that it is unable to support load of the elevator, the helical thread of the sliding nut will contact the helical male groove of the screw shaft to support the load of the elevator;
wherein the sliding nut is exposed out of the ball screw drive mechanism, and a width of the gap is allowed to be measured directly from outside.

2. (canceled)

3. A ball screw drive mechanism for an elevator comprising:
a screw shaft whose outer surface being formed with a helical male groove having an approximate semicircular cross section, an end of the screw shaft locked to a support beam of an elevator, and the screw shaft being fixed in an axial direction with respect to the support beam;
an elevator car-connecting member being connected to an elevator car and being moveable together with the elevator car;
a ball nut being a hollow structure rotatably screwed on the screw shaft and fixed to the elevator car-connecting member, in an inner surface of the ball nut being formed a helical female groove for mating with the helical male groove, a plurality of balls rotatably arranged in a space between the helical male groove and the helical female groove, and thus the ball nut is rotatable relative to the screw shaft, and during rotation, the ball nut will move axially relative to the screw shaft; and
a sliding nut being a hollow structure screwed on the screw shaft and fixed to the elevator car-connecting member, in an inner surface of the sliding nut being formed a helical thread for meshing with the helical male groove of the screw shaft, between the helical thread and the helical male groove is a gap, so that when a relative rotation occurs between the sliding nut and the screw shaft, the sliding nut will move along the screw shaft in such a manner the helical thread of the sliding nut doesn't contact the helical male groove of the screw shaft, however, when the ball nut is worn off so severely that it is unable to support load of the elevator, the helical thread of the sliding nut will contact the helical male groove of the screw shaft to support the load of the elevator;
wherein the sliding nut is exposed out of the ball screw drive mechanism, so that a width of the gap is allowed to be measured directly from outside, and the gap is measured by a thickness gauge.

4. The ball screw drive mechanism for an elevator as claimed in claim 1, wherein the sliding nut is made of metal.

5. The ball screw drive mechanism for an elevator as claimed in claim 4, wherein the metal is steel.

6. (canceled)

7. (canceled)

8. (canceled)

9. (canceled)

10. (canceled)

11. (canceled)

12. The ball screw drive mechanism for an elevator as claimed in claim 1, wherein the elevator car-connecting member is fixed to the elevator car, the screw shaft is connected to a motor, and the motor serves to rotate the screw shaft relative to the ball nut.
